(19) United States
(12) Patent Application Publication
(10) Pub. No.: US 2026/0070224 A1
(43) Pub. Date: Mar. 12, 2026

(54) SYSTEM FOR DETECTING A HAZARDOUS STATE FOR THE SAFE CONTROL OF MOBILE ROBOTS IN A MONITORING AREA OF AN INDUSTRIAL PLANT

(71) Applicant: SICK AG, Waldkirch (DE)

(72) Inventors: Heiko STEINKEMPER, Waldkirch (DE); Michael SCHOTT, Freiburg (DE); Jens GEBAUER, Waldkirch (DE)

(21) Appl. No.: 19/320,255

(22) Filed: Sep. 5, 2025

(30) Foreign Application Priority Data
Sep. 6, 2024 (DE) 10 2024 125 627.3

(51) Int. Cl. B25J 9/16; B25J 5/00; B25J 13/08

(52) U.S. Cl. CPC B25J 9/1674; B25J 5/007; B25J 9/161; B25J 13/089

(57) ABSTRACT

A system for determining a position of at least one subject in a monitored zone of an industrial plant and/or for recognizing a hazardous state for the safeguarded control of at least one robot in the monitored zone of the industrial plant, said system comprising the robot, wherein the robot is mobile, wherein the robot preferably comprises an automated guided vehicle or an autonomous mobile robot; at least one sensor, wherein the sensor is attached to the robot and can be moved along with the robot, wherein the sensor is configured to acquire data of the environment of the robot; and a processing apparatus, wherein the processing apparatus comprises a processor with an associated memory, is connected to the robot and to the sensor and is configured to receive the data acquired by the sensor; based on the acquired data, to determine an absolute position of the robot in the monitored zone, to determine a relative position of the at least one subject, in particular a person, wherein the subject can be present in the monitored zone, relative to the robot and/or to determine an absolute position of the subject in the monitored zone; to recognize a hazardous state based at least on the determined relative position of the subject relative to the robot and/or the determined absolute position of the subject; and to set the robot into a safeguarded control mode when the hazardous state is recognized.

The invention relates to a system, to a use of a processing apparatus, to a method, and to a processing apparatus for determining a position of at least one subject in a monitored zone of an industrial plant and/or for recognizing a hazardous state for the safeguarded control of at least one robot in the monitored zone of the industrial plant.

In an industrial plant, both autonomous and/or other vehicles and robots equipped with sensors, and in particular so-called Autonomous Mobile Robots (AMRs), as well as subjects, and in particular persons, can be present and/or can move in the same monitored zone or hazardous zone at the same time. This poses particular challenges for the control of the AMRs. On the one hand, the safety of the subjects must be ensured, in particular by collision avoidance. Furthermore, an increase in the productivity and efficiency is desired by avoiding and/or reducing (safety-related) downtimes and speed reductions. In order to meet these requirements for the control of the AMRs, the positions of the subjects in a monitored zone should be determined as precisely as possible and should in particular be tracked without interruptions.

Known systems use radio anchor-based or camera-based solutions to determine the positions of subjects in a monitored zone of an industrial plant. In this respect, an elaborate infrastructure of sensors or cameras that are permanently installed in the monitored zones is required, said sensors or cameras acquiring data based on which the positions of the subjects in the monitored zone can be determined. In addition, objects, and in particular metallic objects, that are located in the monitored zone can cause an unwanted shielding of the detection zone of the sensors or cameras so that the number of sensors or cameras must additionally be increased to ensure a sufficient coverage of the monitored zone.

In known systems, marker-based or so-called tag-based solutions can also be used for the position determination of subjects. However, they likewise require a complex infrastructure of sensors and typically a dense network or grid of reference sensors or anchors. Furthermore, the corresponding tags must be taken along by the subjects, e.g. integrated in the helmet, in the high-visibility vest or for a hanging on or hanging around so that the position of a subject can be determined by means of distance measurements between a tag and typically three anchor points.

The invention is based on the underlying object of improving systems for determining a position of at least one subject in a monitored zone of an industrial plant and/or for recognizing a hazardous state for the safeguarded control of mobile robots, and in particular AMRs, in the monitored zone of the industrial plant, and in particular of making said systems more efficient.

A system having the features of claim 1 is provided to satisfy the object. Advantageous embodiments of the invention can be seen from the dependent claims, from the description, and from the drawings.

The system according to the invention for determining a position of at least one subject in a monitored zone of an industrial plant and/or for recognizing or assessing a hazardous state for the safeguarded control of at least one robot in the monitored zone of the industrial plant comprises the at least one robot, wherein the robot is mobile and preferably comprises an automated guided vehicle or an autonomous mobile robot (AMR). It is understood that the robot can preferably be controlled in a normal control mode and/or in a safeguarded control mode. It is likewise understood that the term industrial plant is to be understood broadly here and can, for example, comprise a factory hall, a production hall, a warehouse, a logistics center, a livestock facility, a chemical industry plant, a waste incineration plant or a power plant.

The system according to the invention further comprises at least one sensor, wherein the sensor is attached to the robot, i.e. is coupled to the robot, and can be moved along with the robot. The sensor is configured to acquire data of the environment of the robot, wherein the data acquired by the sensor can preferably be used for a control, and in particular an autonomous control, of the robot in the monitored zone.

The system according to the invention further comprises a processing apparatus, wherein the processing apparatus comprises a processor with an associated memory and is connected to the robot and to the sensor. The processing apparatus can in this respect be in a wired or wireless signal connection, and preferably in a wireless signal connection, with the robot and with the sensor in order to receive data from the sensor and to be able to transmit instructions to the robot.

The processing apparatus of the system according to the invention is configured to receive the data acquired by the sensor; based on the acquired (and obtained) data, to determine an absolute position of the robot in the monitored zone, to determine a relative position of the at least one subject, in particular a person, wherein the subject can be present in the monitored zone, relative to the robot and/or to determine an absolute position of the at least one subject in the monitored zone.

It is understood that the determination of a position can include not only the one-time, but also the repeated, and in particular continuous or regular, determination of the position. In other words, the absolute position of the robot, the relative position of the subject and/or the absolute position of the subject is tracked. It is likewise understood that not only the relative and/or absolute position of a subject, but also the relative and/or absolute positions of a plurality of subjects can be tracked. An absolute position can mean a position in a global coordinate system, e.g. within the monitored zone. The absolute position of the subject can, for example, be calculated based on the relative position of the subject to the robot. The processing apparatus can obtain information about the global coordinate system by detecting a position marker in the monitored zone by means of the sensor. Alternatively or additionally, the processing apparatus can receive information about the global coordinate system from an external memory device with which the processing apparatus is preferably in a wireless signal connection. The processing apparatus can, alternatively or additionally, determine or track the absolute position of the robot by means of odometry. The processing apparatus can, alternatively or additionally, determine or track the absolute position of the robot by means of detecting markings in the monitored zone. However, simply the determination of the relative position of the subject relative to the robot can also be sufficient for the recognition of the hazardous state.

The monitored zone can in particular be that zone which can potentially be detected by the sensor (or sensors).

The processing apparatus is further configured to recognize a hazardous state based at least on the determined relative position of the subject relative to the robot and/or the determined absolute position of the subject; and to set the robot into a safeguarded control mode when the hazardous state is recognized. The processing apparatus can preferably switch the robot from a normal control mode to the safeguarded control mode when the hazardous state is recognized.

In other words, the invention is based on the idea of using the data that are acquired by at least one sensor, which is attached to the mobile robot itself, and that can be used for the autonomous control of the robot, for the tracking of the relative position of the subject relative to the robot and/or for the tracking of the absolute position of the subject in the monitored zone. The relative position of the subject relative to the robot and/or the absolute position of the subject in the monitored zone, based on which the hazardous state is recognized, are ideally tracked without interruptions and kept up to date. In this way, the hazardous state can be recognized more reliably. Further sensors that are attached in a stationary manner in the monitored zone are not necessary, but can still be integrated into the system for redundancy. In the system, all the data that are acquired by the sensor(s) on the mobile robot(s), and also by stationary sensors, can be combined in the processing apparatus in order to track the relative position and or the absolute position of the subject as accurately as possible and ideally without interruptions. The processing apparatus can then recognize the hazardous state based on the combined data in order to set the robot (or robots) into the safeguarded control mode. In other words, all the robots in the system can thus access current information with respect to the relative and/or absolute position of the subject and can be set into the safeguarded control mode centrally via the processing apparatus when the hazardous state is recognized. In this way, the safety of the subjects that are present in the monitored zone can be increased without having to accept excessively long (safety-related) downtimes and speed reductions, which can increase the overall efficiency in the system.

The sensor, the robot and the processing apparatus can each comprise a reception and transmission unit or a reception/transmission unit for data transmission. The processing apparatus can receive the acquired data in that the sensor transmits the acquired data to the processing apparatus and/or the processing apparatus retrieves the data from the sensor. The processor of the processing apparatus can comprise one or more cores, an SoC, a microcontroller and/or an FPGA. The associated memory can be installed in the processing apparatus or can be an external memory or cloud server which the processing apparatus can access.

The acquired data can preferably be used for a simultaneous localization and mapping (SLAM). According to one embodiment, the processing apparatus is configured to determine the absolute position of the robot, the relative position of the subject relative to the robot and/or the absolute position of the subject by means of SLAM. In other words, the processing apparatus can be configured to generate a dynamic map in which the determined absolute position of the robot, the determined relative position of the subject relative to the robot and/or the determined absolute position of the subject are constantly re-entered or already entered corresponding position values are updated or overwritten. It is understood that the dynamic map generated by means of SLAM can be stored in the associated memory in this respect. Preferably, the absolute position of the subject is tracked by means of SLAM. Such a configuration opens up the possibility that a plurality of robots in the system can access the same dynamic map and can be controlled based on the same dynamic map.

According to one embodiment, the processing apparatus is configured to recognize the hazardous state based solely on the determined relative position of the subject relative to the robot and to set the robot into a safeguarded control mode when the hazardous state is recognized.

According to one embodiment, the processing apparatus is configured to determine the absolute position of the subject in the monitored zone based on the determined absolute position of the robot and the determined relative position of the subject relative to the robot. In other words, the absolute position of the robot in the monitored zone can be known so that the absolute position of the subject in the monitored zone can be determined based on the determined relative position of the subject relative to the robot.

According to a further embodiment, the processing apparatus is configured to recognize the hazardous state based on the determined absolute position of the subject and the determined absolute position of the robot. In other words, the system can be configured to continuously determine, update and/or seamlessly monitor the absolute position of the subject and the absolute position of the robot in the monitored zone so that the absolute position of the subject and the absolute position of the robot, based on which the hazardous state is recognized, are ideally essentially known at all times and up-to-date. In this way, the hazardous state can be recognized more reliably.

According to a further embodiment, the processing apparatus is configured to determine a distance between the subject and the robot based on the determined relative position of the subject relative to the robot and to recognize the hazardous state based on the determined distance.

According to one embodiment, the safeguarded control mode comprises a lowering of a speed of movement of the robot, a slowing down of the robot, a moving of the robot into a holding position, a safety operation, a change of the direction of movement of the robot, a change of a route of the robot, an immobilization of the robot, a stopping of the movement of the robot, a redirection of the robot, and/or a change of a movement sequence of the robot, a change of an action performed by the robot.

Preferably, the safeguarded control mode comprises, alternatively or additionally, the instruction that the robot aligns the sensor attached to it with the subject and/or tracks the subject in the monitored zone. In this way, the relative position of the subject relative to the robot and/or the absolute position of the subject in the monitored zone can be tracked without interruptions. Preferably, the safeguarded control mode comprises both reducing the speed of movement of the robot and instructing the robot to align the sensor attached to it with the subject and/or to track the subject in the monitored zone.

According to one embodiment, the sensor comprises a camera, a radio module, a laser scanner, a tag reading device, a GPS module and/or an ultrasonic sensor. It is understood that the camera can be a 3D camera, a 2D camera using appropriate algorithms, and/or a 2D camera using visual markers. In particular, the camera can be a ToF (Time of Flight) camera. It is understood that the tag can be an RFID (Radio-Frequency Identification) tag, for example. However, a tag can also refer to a (visual) reference marking and/or a QR code. It is understood that so many tags can be placed in the environment that there is always at least one tag in the detection zone of the sensor attached to the robot.

According to one embodiment, the hazardous state comprises the presence of the subject in the monitored zone or in a part of the monitored zone, the entry into the monitored zone or the part of the monitored zone by the subject, a reaching or an exceeding of a number of subjects in the monitored zone or in the part of the monitored zone, the reaching or falling below of a distance of the robot from the subject, the presence of the robot in a protected zone in the monitored zone, the movement of the robot into the protected zone, the presence of the robot in a location zone of the subject and/or the movement of the robot into the location zone of the subject. It is understood that the part of the monitored zone can be predefined and can in particular correspond to a zone that can be traveled by the robot. Additionally or alternatively, the part of the monitored zone can correspond to the field of view of the sensor. The so-called protected zone or the so-called protected field can be a part of the monitored zone, and in particular a part of the field of view of a sensor, wherein a warning signal can be output if the protected zone is violated, e.g. by a person or a robot, in particular an autonomous robot.

According to one embodiment, the location zone of the subject is based on a possible location of the subject or corresponds to an area or a volume of a possible location of the subject, wherein the possible location of the subject is based on the determined relative position of the subject relative to the robot and/or the determined absolute position of the subject. In other words, the location zone of the subject can refer to a zone in which the subject is or will be located with at least a predetermined probability. The probability of the location for a position within the location zone can be determined based on the last determined position of the subject, its position and/or size and/or its speed of movement and/or direction of movement. The further away the position is from the last determined position of the subject, the longer ago the last position determination is and/or the less the position is in the direction of movement of the subject, the lower the probability of the presence for this position may be. In a corresponding manner, the location zone can correspond to a zone disposed around the last determined position of the subject, the location and/or size of said zone can be determined according to the time that has elapsed since the last position determination, the last determined (or known) position at a certain time point in time t₁, the speed of movement and/or the direction of movement of the subject. In other words, the more time that has elapsed and the greater the possible speed of movement, the larger the area or the volume of the potential location zone can be, provided that said location zone is not limited by other factors such as a wall or the detection zone of a sensor. Starting from the last determined position at the point in time t₁, a probability for the further movement can be calculated in dependence on the direction of movement, the speed of movement and/or a movement vector (i.e. with the direction of movement and speed of movement as components) and the elapsed time period Δt. For example, the location zone can correspond to a circular region around the last determined position of the subject or a triangle in which one corner is defined by the last determined position of the subject and/or the associated height of the triangle is defined by the direction of movement, the speed of movement and/or the movement vector.

According to one embodiment, regions that cannot be entered by the subject (e.g. due to existing physical barriers) and/or regions that are located in the field of view of mobile sensors attached to a robot and/or in the field of view of stationary sensors are excluded from the location zone of the subject.

The size and/or the position of the location zone of the subject can preferably be changed, and can in particular be reduced, enlarged, shifted and/or rotated. If, for example, an AMR enters an aisle in which a subject was last detected before this subject could theoretically have reached the corresponding end of the aisle, and if no subject can be detected based on the data acquired during the journey through the aisle, the location zone of the subject in this region can be reduced again. In the event of a new detection, an exact position of the subject would understandably be known again.

According to one embodiment, the location zone of the subject is reduced when the processing apparatus recognizes, based on data acquired by a further sensor, that the subject leaves the location zone and/or is not (no longer) present in the location zone. The further sensor can, for example, be a second sensor in the system, said second sensor being attached to a second robot, and can acquire data while the second robot moves into the location zone of the subject and/or passes through the location zone of the subject. If no subject can then be detected in the data acquired by the second sensor, the location zone of the subject can be reduced. In addition or alternatively, the location zone of the subject is reduced when the processing apparatus recognizes, based on data acquired by a further sensor, that the subject enters the location zone and/or is (still) present in the location zone, i.e. if the processing apparatus (in particular after a certain time period has elapsed) can again determine a current position of the subject in the location zone based on the data acquired by a further sensor. Therefore, if a subject can be detected in the data acquired by the second sensor, the location zone of the subject can be reduced since a current (and precise) position of the subject is known again.

Additionally or alternatively, the location zone of the subject can also be enlarged if the processing apparatus recognizes, based on data acquired by the first sensor and by the further sensor, that the subject (contrary to expectations) is present in the location zone. For example, the subject can have last been detected in a narrow aisle, e.g. at a point in time T₁. A robot with in each case at least one sensor can then enter the aisle from both sides, wherein the sensors can preferably detect the entire aisle width in each case. If the two robots then meet in the aisle at a later point in time, e.g. T₂, after a certain time period, e.g. Δt, has elapsed without the subject having been detected by at least one of the two sensors, it can be concluded that the subject has misbehaved and, for example, has climbed onto or over a barrier (e.g. a fence, a shelf, or similar). For such or similar situations, it is conceivable to (abruptly) enlarge the location zone, and indeed preferably to a size which not only a walking (or running) but also a climbing subject could have reached with at least a predetermined probability since the last determination of its position. Additionally or alternatively, a warning signal can be output.

In this way, the location zone of the subject can be dynamically adapted. It is understood that a third sensor, which is attached in a stationary manner in the monitored zone, can be used for this purpose in addition to or as an alternative to the further or second sensor.

According to one embodiment, the apparatus is configured to recognize a safety state based on the acquired (and obtained) data, wherein the apparatus switches the robot from the safeguarded control mode to a normal control mode when the safety state is recognized. The safety state preferably comprises the absence of the subject from the monitored zone or the part of the monitored zone, the leaving of the monitored zone or the part of the monitored zone by the subject, an exceeding of a number of subjects in the monitored zone or in the part of the monitored zone, the exceeding of a distance of the robot from the subject, the absence of the robot from the protected zone, the movement of the robot out of the protected zone, the absence of the robot from the location zone of the subject and/or the movement of the robot out of the location zone of the subject.

According to one embodiment, the sensor is a first sensor and the robot is a first robot. The system then additionally comprises (at least) a second robot and (at least) a second sensor, wherein the second sensor is attached to the second robot, i.e. is coupled to the second robot, and can be moved along with the second robot. In other words, there is at least one sensor at each robot in the system, which sensor preferably acquires data for an autonomous control of the (mobile) robot coupled to it. The processing apparatus is configured to receive data (additionally) acquired by the second sensor and to use said data for the determination of the absolute position of the second robot, a relative position of the subject relative to the second robot and/or the absolute position of the subject. The processing apparatus is further configured to recognize a hazardous state based at least on the determined relative position of the subject relative to the first robot, the determined relative position of the subject relative to the second robot and/or the determined absolute position of the subject. The processing apparatus is preferably configured to set the first robot and/or the second robot, in particular from a normal control mode, into a safeguarded control mode when the hazardous state is recognized. It is understood that the first robot and the second robot are preferably set into the same safeguarded control mode or into a different safeguarded control mode in each case. In other words, the data acquired by a plurality of sensors are centrally combined in the processing apparatus and are used to recognize the hazardous state. Starting from the processing apparatus, in response to the recognition of the hazardous state, selected robots or all the robots in the system can then be set into a safeguarded control mode. In this way, the safety and the reliability of the system can be increased.

According to one embodiment, the second sensor comprises a camera, a radio module, a laser scanner, a tag reading device, a GPS module and/or an ultrasonic sensor. The first and the second sensor can be sensors of the same type or of a different type.

According to one embodiment, the safeguarded control mode, additionally or alternatively, comprises the instruction that the first robot aligns the first sensor attached to it with the subject and/or tracks the subject in the monitored zone until the relative position of the subject relative to the second robot and/or the absolute position of the subject can be determined based on the data acquired by the second sensor. In this way, the position of the subject in the monitored zone can be tracked without interruptions.

According to one embodiment, the system comprises (at least) a third sensor. The processing apparatus is then configured to receive data acquired by the third sensor and to use said data for the determination of the absolute position of the first robot, the absolute position of the second robot, the relative position of the subject relative to the first robot, the relative position of the subject relative to the second robot, and/or the absolute position of the subject. The third sensor preferably comprises a camera, a radio module, a laser scanner, a tag reading device, a GPS module, a mobile end device, in particular a smartphone or a tablet, augmented reality glasses, a pressure sensor and/or an ultrasonic sensor. The type of the third sensor is preferably different from the type of the first sensor and/or the type of the second sensor. By additionally using the data acquired by the third sensor for the determination of the absolute position of the first robot, the absolute position of the second robot, the relative position of the subject relative to the first robot, the relative position of the subject relative to the second robot and/or the absolute position of the subject, a redundancy can be provided and the safety in the system can thereby be increased.

According to one embodiment, the third sensor can be moved along with the subject and can in particular be carried along. According to an alternative embodiment, the third sensor can be attached in a stationary manner in the monitored zone. It is understood that even further sensors can also be present in the system, wherein the further sensors comprise sensors that can be carried along by the subject, on the one hand, and other sensors that are attached in a stationary manner in the monitored zone, on the other hand.

It is understood that the system can comprise a number of 1 to n robots, to each of which 1 to m sensors are attached. Furthermore, the system can additionally comprise 1 to k sensors that are attached in a stationary manner in the monitored zone and/or 1 to l sensors that can be moved along by the subject.

According to one embodiment, the third sensor is configured to observe an access to the monitored zone or an access to a part of the monitored zone and to acquire data in so doing, wherein the processing apparatus is configured, based on the data acquired by the third sensor, to determine the presence and/or absence of the subject in the monitored zone or in the part of the monitored zone, to determine the entry and/or leaving of the monitored zone or the part of the monitored zone by the subject and/or to determine a number of subjects in the monitored zone or in the part of the monitored zone. In other words, an input counting and/or output counting takes place that can, for example, also be realized by a user input that is detected by the third sensor. The processing apparatus can, based on the data acquired by the third sensor (in particular together with the data acquired by the other sensors), more accurately track how many subjects are in the monitored zone at any point in time.

According to one embodiment, the processing apparatus is configured to recognize the hazardous state based on the number of subjects in the monitored zone, which number is determined based on the data acquired by the third sensor, deviating from, and in particular being greater than, the number of subjects in the monitored zone, which number is determined based on the data acquired by the first sensor and/or the second sensor. In other words, the hazardous state can comprise that not all the subjects present in the monitored zone are detected by the sensors attached to the robots. To restore a safe operation, for example, all the robots that are located in the monitored zone or in the part of the monitored zone can then be set into a safeguarded control mode.

A further subject of the invention is the use of a system described herein for determining a position of at least one subject in a monitored zone of an industrial plant and/or for recognizing a hazardous state for the safeguarded control of at least one robot in the monitored zone of the industrial plant.

A further subject of the invention is a processing apparatus for determining a position of at least one subject in a monitored zone of an industrial plant and/or for recognizing a hazardous state for the safeguarded control of at least one robot in the monitored zone of the industrial plant. The processing apparatus comprises a processor with an associated memory. The processing apparatus can be connected to the robot, wherein the robot is mobile and preferably comprises an automated guided vehicle or an autonomous mobile robot. The processing apparatus can further be connected to at least one sensor, wherein the sensor is attached to the robot and can be moved along with the robot, wherein the sensor is configured to acquire data of the environment of the robot. The processing apparatus can be connectable to different types of sensors.

According to the invention, the processing apparatus is configured to receive the data acquired by the sensor; based on the acquired data, to determine an absolute position of the robot in the monitored zone, to determine a relative position of the at least one subject, in particular a person, wherein the subject can be present in the monitored zone, relative to the robot and/or to determine an absolute position of the subject in the monitored zone, to recognize a hazardous state based at least on the determined relative position of the subject relative to the robot and/or the determined absolute position of the subject; and to set the robot into a safeguarded control mode when the hazardous state is recognized.

A further subject of the invention is a method for determining a position of at least one subject in a monitored zone of an industrial plant and/or for recognizing a hazardous state for the safeguarded control of at least one robot in the monitored zone of the industrial plant, wherein the robot is mobile and preferably comprises an automated guided vehicle or an autonomous mobile robot. In the method according to the invention, data of the environment of the robot are acquired by means of a sensor that is attached to the robot and that can be moved along with the robot. Based on the acquired data, an absolute position of the robot in the monitored zone, a relative position of the at least one subject, in particular a person, wherein the subject can be present in the monitored zone, relative to the robot and/or an absolute position of the subject in the monitored zone is/are determined. A hazardous state is recognized based at least on the determined relative position of the subject relative to the robot and/or the determined absolute position of the subject. When the hazardous state is recognized, the robot is set into a safeguarded control mode.

It is understood that what is described with respect to the system according to the invention also applies to the use of the system, to the processing apparatus and to the method. This in particular applies to embodiments and advantages.

Furthermore, it is to be understood that all the features and embodiments disclosed herein can be combined unless expressly stated otherwise.

The invention will be described in the following purely by way of example with reference to possible embodiments and to the enclosed drawing. There are shown:

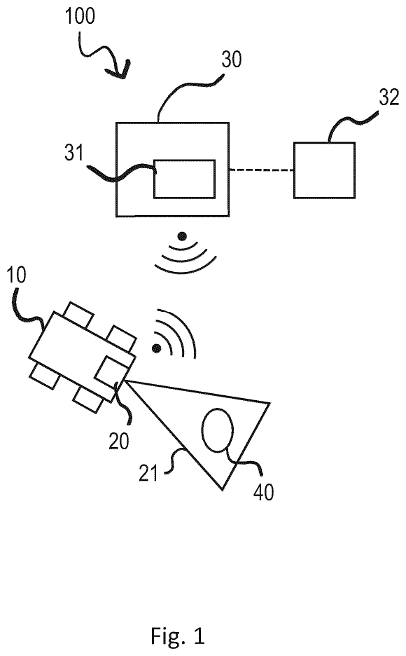

FIG. 1 a schematic representation of a system according to an embodiment of the invention;

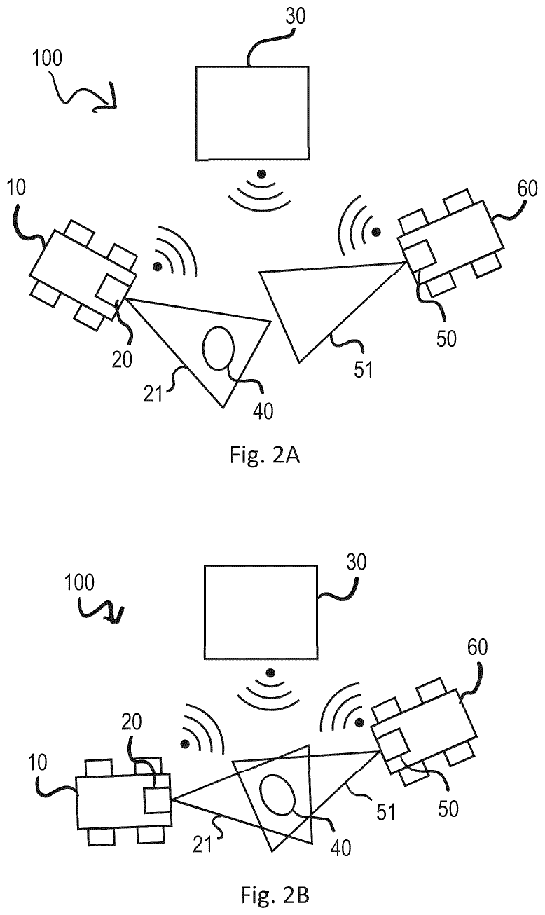

FIG. 2A a schematic representation of a system according to an embodiment of the invention in a first situation;

FIG. 2B a schematic representation of the system of FIG. 2A in a second situation;

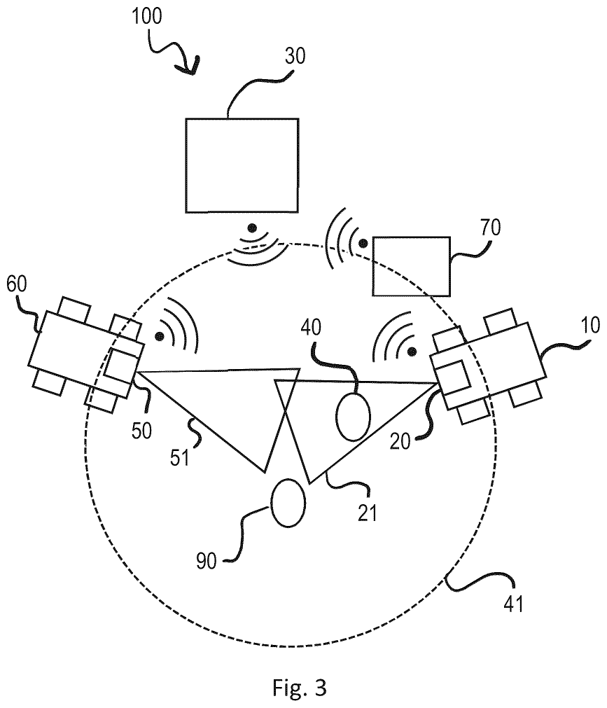

FIG. 3 a schematic representation of a system according to an embodiment of the invention;

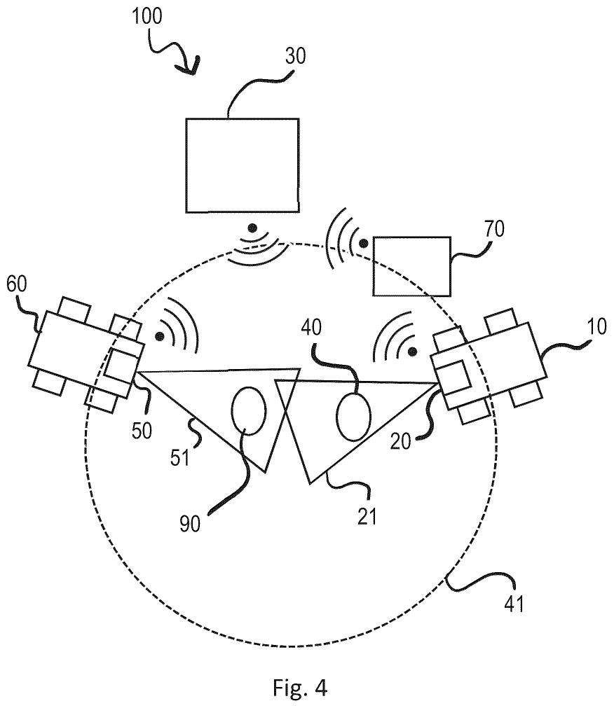

FIG. 4 a schematic representation of a system according to an embodiment of the invention; and

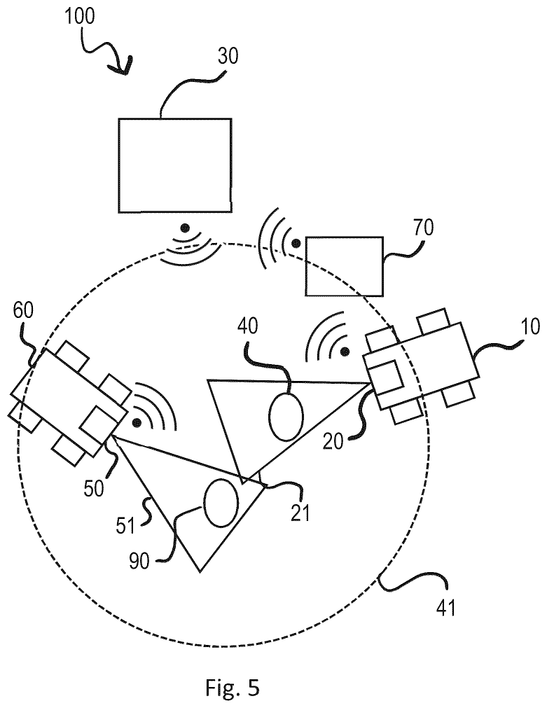

FIG. 5 a schematic representation of the system according to an embodiment of the invention.

The system 100 shown in FIG. 1 comprises at least one robot 10 which is mobile, which preferably comprises an automated guided vehicle or an autonomous mobile robot and which is located in a monitored zone (not shown in FIG. 1) of an industrial plant. The system 100 further comprises at least one sensor 20, wherein the sensor 20 is attached to the robot 10 and can be moved along with the robot 10. The sensor 20 is configured to acquire data of the environment of the robot 10. The sensor 20 can, for example, be a 3D camera and can in particular be a ToF camera. The system 100 furthermore comprises a processing apparatus 30, wherein the processing apparatus 30 comprises a processor 31 with an associated memory 32. The memory 32 can be part of the processing apparatus 30 or can be an external memory that can be accessed by the processing apparatus 30. The processing apparatus 30 is connected to the robot 10 and to the sensor 20, preferably by means of a wireless signal connection, and is configured to receive the data acquired by the sensor 20. The processing apparatus 30 is further configured, based on the acquired data, to determine an absolute position of the robot 10 in the monitored zone, to determine a relative position of at least one subject 40, in particular a person, wherein the subject 40 can be in the monitored zone, relative to the robot 10 and/or to determine an absolute position of the subject 40 in the monitored zone. The processing apparatus 30 is further configured to recognize a hazardous state based at least on the determined relative position of the subject 40 relative to the robot 10 and/or the determined absolute position of the subject 40, and to set the robot 10 into a safeguarded control mode when the hazardous state is recognized.

The processing apparatus 30 in FIG. 1 can be configured to determine the absolute position of the robot 10, the relative position of the subject 40 and/or the absolute position of the subject 40, preferably by means of SLAM. In other words, the processing apparatus 30 is configured to generate a dynamic map in which the determined absolute position of the robot 10, the determined relative position of the subject 40 relative to the robot 10 and/or the determined absolute position of the subject 40 are constantly re-entered or already entered corresponding position values are updated or overwritten. It is understood that the dynamic map generated by means of SLAM can in this respect be stored in the associated memory 32.

In the system 100 in FIG. 1, the safeguarded control mode can comprise a lowering of a speed of movement of the robot 10, a slowing down of the robot 10, a moving of the robot 10 into a holding position, a safety operation, a change of the direction of movement of the robot 10, a change of a route of the robot 10, an immobilization of the robot 10, a stopping of the movement of the robot 10, a redirection of the robot 10, and/or a change of a movement sequence of the robot 10, a change of an action performed by the robot 10.

In the system 100 shown in FIG. 1, the safeguarded control mode can, additionally or alternatively, comprise the instruction that the robot 10 aligns the sensor 20 attached to it, and in particular the field of view 21 of the sensor 20, with the subject 40 and/or tracks the subject 40 in the monitored zone. The sensor can, for example, be rotatably attached to the robot 10. The robot 10 can then comprise a motorized holder for the sensor, wherein the motor (not shown in FIG. 1) is activated and rotates the sensor when the robot 10 receives the instruction from the processing apparatus 30. In this way, the field of view 21 of the sensor 20 can be aligned with the subject 40. It is conceivable that the robot 10, additionally or alternatively, in response to receiving the instruction, tracks the subject 40 in the monitored zone while maintaining a predefined safety distance.

The system 100 shown in FIG. 2A and FIG. 2B comprises similar or the same components as the system 100 in FIG. 1, wherein the sensor 20 is a first sensor 20 and the robot 10 is a first robot 10. The system 100 in FIG. 2A and FIG. 2B additionally comprises a second robot 60 and a second sensor 50, wherein the second sensor 50 is attached to the second robot 60 and can be moved along with the second robot 60. It is understood that the second robot 60 is likewise mobile, preferably comprises an automated guided vehicle or an autonomous mobile robot, and is located in the monitored zone (not shown in FIG. 2A and FIG. 2B) of the industrial plant. It is understood that the processing apparatus 30 is connected to the second robot 60 and to the second sensor 50 preferably by means of a wireless signal connection. In the system 100 in FIG. 2A and FIG. 2B, the processing apparatus 30 is configured to (additionally) receive data acquired by the second sensor 50 and to use said data for the determination of the absolute position of the second robot 60, a relative position of the subject 40 relative to the second robot 60 and/or the absolute position of the subject 40. The processing apparatus 30 in FIG. 2A and FIG. 2B is further configured to recognize a hazardous state based at least on the determined relative position of the subject 40 relative to the first robot 10, the determined relative position of the subject 40 relative to the second robot 60, and/or the determined absolute position of the subject 40. The processing apparatus 30 in FIG. 2A and FIG. 2B is furthermore configured to set the first robot 10 and/or the second robot 60 into a safeguarded control mode when the hazardous state is recognized. The first robot 10 and the second robot 60 can be set into the same safeguarded control mode or into a different safeguarded control mode in each case.

In other words, the data acquired by the first sensor 20 and the second sensor 50 are centrally combined in the processing apparatus 30 and are used to recognize the hazardous state. The processing apparatus 30 can then be configured, in response to the recognition of the hazardous state, to set the first robot 10 or the second robot 60 or both robots 10, 60 into a safeguarded control mode. In this way, the safety and the reliability of the system 100 can be increased.

In FIG. 2A, the system 100 is shown in a first situation in which the subject 40 located in the field of view 21 of the first sensor 21. The processing apparatus 30 can then, based on the data acquired by the first sensor 20, determine a relative position of the subject 40 relative to the first robot 10 and/or an absolute position of the subject 40 in the monitored zone, can recognize the hazardous state and can set the first and/or second robot 10, 60 into the safeguarded control mode. The safeguarded control mode can then comprise the instruction that the first robot 10 aligns the first sensor 20 attached to it with the subject 40 so that the field of view 21 of the sensor 20 is directed (and in particular remains directed) towards the subject 40, and/or tracks the subject 40 in the monitored zone until the subject is likewise in the field of view 51 of the second sensor 50, as shown in the second situation illustrated in FIG. 2B, and subsequently the relative position of the subject 40 relative to the second robot 60 and/or the absolute position of the subject 40 can be determined from the data acquired by the second sensor 50. It is understood that the instruction can additionally comprise that the second robot 60 directs the second sensor 50 towards the subject 40 so that the field of view 51 of the second sensor 50 is directed towards the subject 40. In this way, the position of the subject 40 in the monitored zone can be tracked as seamlessly as possible.

The system 100 shown in FIG. 3 comprises similar or the same components as the system 100 in FIG. 2A and FIG. 2B. The system 100 in FIG. 3 additionally comprises a third sensor 70. The processing apparatus 30 of the system 100 in FIG. 3 is then configured to (additionally) receive data acquired by the third sensor 70 and to use said data for the determination of the absolute position of the first robot 10, the absolute position of the second robot 60, the relative position of the subject 40 relative to the first robot 10, the relative position of the subject 40 relative to the second robot 60, and/or the absolute position of the subject 40. It is understood that the subject 40 can be a first subject 40 and that there can also be a plurality of subjects and in particular a second subject 90 in the monitored zone 41. Accordingly, the processing apparatus 30 of the system in FIG. 3 is configured to likewise determine the position of the second subject 90 relative to the first robot 10, the relative position of the second subject 90 relative to the second robot 60 and/or the absolute position of the second subject 90 in the monitored zone.

The third sensor 70 of the system 100 in FIG. 3 preferably comprises a camera, a radio module, a laser scanner, a tag reading device, a GPS module, a mobile end device, in particular a smartphone or a tablet, augmented reality glasses, and/or an ultrasonic sensor. The third sensor 70 can, for example, be moved along and in particular carried along by one of the subjects 40, 90. In this case, the third sensor 70 preferably comprises a mobile device, in particular a smartphone or a tablet, or augmented reality glasses. Alternatively, the third sensor 70 can be attached in a stationary manner in the monitored zone. It is understood that even further sensors can also be present in the system, wherein the further sensors comprise sensors that can be carried along by the subjects 40, 90, on the one hand, and other sensors that are attached in a stationary manner in the monitored zone, on the other hand.

The third sensor 70 of the system 100 in FIG. 3 can, for example, be configured to observe an access to the monitored zone 41 or an access to a part of the monitored zone 41 and to acquire data in so doing. The processing apparatus 30 in FIG. 3 is then configured, based on the data acquired by the third sensor 70, to determine the presence and/or absence of the first subject 40 and/or the second subject 90 in the monitored zone 41 or in the part of the monitored zone 41, to determine the entry and/or leaving of the monitored zone 41 or the part of the monitored zone 41 by the first subject 40 and/or the second object 90, and/or to determine a number of subjects 40, 90 in the monitored zone 41 or in the part of the monitored zone 41. In other words, the third sensor 70 provides an output count and/or an input count. In the example shown in FIG. 3, there are two subjects in the monitored zone 41, but the number of subjects in the monitored zone 41 can also be fewer than two or more than two.

In the system 100 shown in FIG. 3, the processing apparatus 30 can be configured to recognize the hazardous state based on the number of subjects 40,90 in the monitored zone 41, which number is determined based on the data acquired by the third sensor 70, deviating from, and in particular being greater than, the number of subjects 40,90 in the monitored zone 41, which number is determined based on the data acquired by the first sensor 20 and/or the second sensor 50.

In the example shown in FIG. 3, the recognized hazardous state can therefore comprise the following. The processing apparatus 30 determines, based on the data acquired by the third sensor 70, that two subjects 40,90 must be present (at a specific point in time) in the monitored zone 41. However, since, as shown by way of example in FIG. 3, only the first subject 40 is located in the field of view 21 of the first sensor 20 and the second subject is not located (at the specific point in time) in any field of view 21,51 of the sensors 20,50, the processing apparatus 30 can determine that (at the specific point in time) only the first subject 40 can be detected in the data acquired by the sensors 20,50 attached to the robots 10,60. In this way, the processing apparatus 30 can recognize the hazardous state. To restore a safe operation, the two robots 10, 60 that are located in the monitored zone 41 or in the part of the guarding zone 41 can then, for example, be set into a safeguarded control mode by means of the processing apparatus 30.

For example, as shown for the system 100 illustrated in FIG. 4, the first robot 10 and the second robot 60 can, in response to the recognition of the hazardous state, be switched from a normal control mode to a safeguarded control mode in that both a movement of the first robot 10 and a movement of the second robot 60 are stopped. If the second subject 90 subsequently moves into the field of view 21,51 of one of the sensors 20,50 and can therefore be detected in the data acquired by the sensors 20,50, the hazardous state can be canceled and/or a corresponding safety state can be recognized by means of the processing apparatus 30. The first robot 10 and the second robot 60 can then be switched from the safeguarded control mode back to the normal control mode.

Alternatively thereto, as shown for the system 100 illustrated in FIG. 5, in response to the recognition of the hazardous state, the first robot 10 and the second robot 60 can be switched from a normal control mode to a safeguarded control mode in that a movement of the first robot 10 is stopped and a speed of movement of the second robot 60 is lowered so that the second robot 60 can continue to move in the monitored zone while still slowed down. The field of view 51 of the second sensor 50 can be moved further with the movement of the second robot 60 until the second subject 90 is detected in the field of view 51 of the second sensor 50 and can subsequently be detected in the data acquired by the sensors 20, 50. The hazardous state can then be canceled and/or a corresponding safety state can be recognized by means of the processing apparatus 30. The first robot 10 and the second robot 60 can then be switched from the safeguarded control mode back to the normal control mode. The first robot 10 and/or the second robot 60 can then continue to move at their normal speed, for example.

1-15. (canceled)

16. A system for determining a position of at least one subject in a monitored zone of an industrial plant and/or for recognizing a hazardous state for the safeguarded control of at least one robot in the monitored zone of the industrial plant, said system comprising
the robot, wherein the robot is mobile;
at least one sensor, wherein the sensor is attached to the robot and can be moved along with the robot, wherein the sensor is configured to acquire data of the environment of the robot; and
a processing apparatus, wherein the processing apparatus comprises a processor with an associated memory, is connected to the robot and to the sensor and is configured
to receive the data acquired by the sensor;
based on the acquired data, to determine an absolute position of the robot in the monitored zone, to determine a relative position of the at least one subject, wherein the subject can be present in the monitored zone, relative to the robot and/or to determine an absolute position of the subject in the monitored zone;
to recognize a hazardous state based at least on the determined relative position of the subject relative to the robot and/or the determined absolute position of the subject; and
to set the robot into a safeguarded control mode when the hazardous state is recognized.

17. The system according to claim 16, wherein the processing apparatus is configured to determine the absolute position of the robot, the relative position of the subject and/or the absolute position of the subject.

18. The system according to claim 16, wherein the safeguarded control mode comprises a lowering of a speed of movement of the robot, a slowing down of the robot, a moving of the robot into a holding position, a safety operation, a change of the direction of movement of the robot, a change of a route of the robot, an immobilization of the robot, a stopping of the movement of the robot, a redirection of the robot, and/or a change of a movement sequence of the robot, a change of an action performed by the robot.

19. The system according to claim 16, wherein the safeguarded control mode comprises the instruction that the robot aligns the sensor attached to it with the subject and/or tracks the subject in the monitored zone.

20. The system according to claim 16, wherein the sensor comprises a camera, a radio module, a laser scanner, a tag reading device, a GPS module and/or an ultrasonic sensor.

21. The system according to claim 16, wherein the hazardous state comprises the presence of the subject in the monitored zone or in a part of the monitored zone, the entry into the monitored zone or the part of the monitored zone by the subject, a reaching or an exceeding of a number of subjects in the monitored zone or in the part of the monitored zone, the reaching or falling below of a distance of the robot from the subject, the presence of the robot in a protected zone in the monitored zone, the movement of the robot into the protected zone, the presence of the robot in a location zone of the subject and/or the movement of the robot into the location zone of the subject.

22. The system according to claim 21, wherein the location zone of the subject is based on a possible location of the subject, wherein the possible location of the subject is based on the determined relative position of the subject relative to the robot and/or the determined absolute position of the subject.

23. The system according to claim 22,
wherein the location zone of the subject is reduced when the processing apparatus recognizes, based on data acquired by a further sensor, that the subject leaves the location zone and/or is not present in the location zone; and/or
wherein the location zone of the subject is reduced when the processing apparatus recognizes, based on data acquired by a further sensor, that the subject enters the location zone and/or is present in the location zone.

24. The system according to claim 16,
wherein the sensor is a first sensor and the robot is a first robot.
wherein the system comprises a second robot and a second sensor;
wherein the second sensor is attached to the second robot and can be moved along with the second robot, and
wherein the processing apparatus is configured to receive data acquired by the second sensor and to use said data for the determination of the absolute position of the second robot, a relative position of the subject relative to the second robot and/or the absolute position of the subject, and
wherein the processing apparatus is configured to recognize a hazardous state based at least on the determined relative position of the subject relative to the first robot, the determined relative position of the subject relative to the second robot and/or the determined absolute position of the subject.

25. The system according to claim 24, wherein the safeguarded control mode comprises the instruction that the first robot aligns the first sensor attached to it with the subject and/or tracks the subject in the monitored zone until the relative position of the subject relative to the second robot and/or the absolute position of the subject can be determined based on the data acquired by the second sensor.

26. The system according to claim 16, wherein the system comprises a third sensor, and wherein the processing apparatus is configured to receive data acquired by the third sensor and to use said data for the determination of the absolute position of the first robot, the absolute position of the second robot, the relative position of the subject relative to the first robot, the relative position of the subject relative to the second robot, and/or the absolute position of the subject.

27. The system according to claim 26, wherein the third sensor is configured to observe an access to the monitored zone or an access to a part of the monitored zone and to acquire data in so doing, wherein the processing apparatus is configured, based on the data acquired by the third sensor, to determine the presence and/or absence of the subject in the monitored zone or in the part of the monitored zone, to determine the entry and/or leaving of the monitored zone or the part of the monitored zone by the subject, and/or to determine a number of subjects in the monitored zone or in the part of the monitored zone.

28. Method of using a system according to claim 16 for determining a position of at least one subject in a monitored zone of an industrial plant and/or for recognizing a hazardous state for the safeguarded control of at least one robot in the monitored zone of the industrial plant.

29. A processing apparatus for determining a position of at least one subject in a monitored zone of an industrial plant and/or for recognizing a hazardous state for the safeguarded control of at least one robot in the monitored zone of the industrial plant,
wherein the processing apparatus comprises a processor with an associated memory,
wherein the processing apparatus can be connected to the robot, wherein the robot is mobile,
wherein the processing apparatus can be connected to at least one sensor, wherein the sensor is attached to the robot and can be moved along with the robot, wherein the sensor is configured to acquire data of the environment of the robot, and
wherein the processing apparatus is configured
to receive the data acquired by the sensor;
based on the acquired data, to determine an absolute position of the robot in the monitored zone, to determine a relative position of the at least one subject, wherein the subject can be present in the monitored zone, relative to the robot and/or to determine an absolute position of the subject in the monitored zone;
to recognize a hazardous state based at least on the determined relative position of the subject relative to the robot and/or the determined absolute position of the subject; and
to set the robot into a safeguarded control mode when the hazardous state is recognized.

30. A method for determining a position of at least one subject in a monitored zone of an industrial plant and/or for recognizing a hazardous state for the safeguarded control of at least one robot in the monitored zone of the industrial plant, wherein the robot is mobile,
wherein data of the environment of the robot are acquired by means of a sensor that is attached to the robot and can be moved along with the robot,
wherein, based on the acquired data, an absolute position of the robot in the monitored zone, a relative position of the at least one subject, wherein the subject can be present in the monitored zone, relative to the robot and/or an absolute position of the subject in the monitored zone is/are determined,
wherein, based at least on the determined relative position of the subject relative to the robot and/or the determined absolute position of the subject, a hazardous state is recognized, and
wherein the robot is set into a safeguarded control mode when the hazardous state is recognized.

31. The system according to claim 16, wherein the robot comprises an automated guided vehicle or an autonomous mobile robot.

32. The system according to claim 16, the at least one subject is a person.

33. The system according to claim 16, wherein the processing apparatus is configured to determine the absolute position of the robot, the relative position of the subject and/or the absolute position of the subject by means of SLAM.

34. The system according to claim 24, wherein the processing apparatus is configured to set the first robot and/or the second robot into a safeguarded control mode when the hazardous state is recognized.

35. The system according to claim 26, wherein the third sensor comprises a camera, a radio module, a laser scanner, a tag reading device, a GPS module, a mobile end device, augmented reality glasses, and/or an ultrasonic sensor.

36. The system according to claim 27, wherein the processing apparatus is configured to recognize the hazardous state based on a number of subjects in the monitored zone, which number is determined based on the data acquired by the third sensor, deviating from a number of subjects in the monitored zone, which number is determined based on the data acquired by the first sensor and/or the second sensor.

37. The system according to claim 22, wherein the size and/or the position of the location zone of the subject is/are changeable.
